(19) United States
(12) Patent Application Publication
(10) Pub. No.: US 2009/0253337 A1
(43) Pub. Date: Oct. 8, 2009

(54) APPARATUS AND METHOD FOR BAKING FLUORESCENT LAMP

(76) Inventors: Min-Suk KIM, Uiwang-si (KR); Kang-Heum Lee, Cheongju-si (KR); Tai-Hee Kim, Seoul (KR); Eun-Suk Kim, Seongnam-si (KR); Min-Soo Kim, Seongnam-si (KR)

Correspondence Address: KED & ASSOCIATES, LLP, P.O. Box 221200, Chantilly, VA, 20153-1200, US

(21) Appl. No.: 12/262,475

(22) Filed: Oct. 31, 2008

(30) Foreign Application Priority Data
Apr. 2, 2008 (KR) 10-2008-0030593

(51) Int. Cl. H01J 9/00

(52) U.S. Cl. 445/60

(57) ABSTRACT

This disclosure relates to an apparatus and a method for making or baking a fluorescent lamp. An apparatus for baking a fluorescent lamp includes a heater to heat a plurality of quartz tubes. Each tube has a fluorescent lamp provided therein. A plurality of rollers rotates the quartz tubes placed thereon, and a transfer block has a plurality of auxiliary rollers. The transfer block is configured to move in a first direction to transfer the plurality of quartz tubes from the plurality of rotating rollers to the plurality of auxiliary rollers. A process for heating at least one fluorescent lamp includes a step of providing a plurality of quartz tubes on a plurality of rotating rollers, at least one quartz tube having a fluorescent lamp provided therein, heating the plurality of quartz tubes while being rotated on the plurality of rollers, and transferring the plurality of quartz tube using a transfer block having a plurality of auxiliary rollers.

### BACKGROUND

1. Field

This application relates to an apparatus and a method for making a fluorescent lamp, and in more particular, baking a fluorescent lamp.

2. General Background

Thin-tube lamps are widely used as backlighting sources for LCD panels. A thin-tube lamp may have an outer diameter of several millimeters. Examples of such thin-tube lamps include a cold cathode fluorescent lamp (CCFL) and an external electrode fluorescent lamp (EEFL).

The structure of a general CCFL 10 is shown in FIG. 1. The CCFL 10 comprises a relatively long glass tube 11, and two electrodes including an anode electrode 12 and a cathode electrode 13 on ends of the long glass tube 11. The two electrodes are connected with leads 16 formed on the both ends of the glass tube 11. In addition, a fluorescent substance 14 is applied on an inner wall of the glass tube 11. An inner space 15 of the glass tube 11 is filled with a gas compound containing mercury (Hg) vapor, argon, (At), neon (Ne), etc.

An EEFL 20 structure is shown in FIG. 2. More specifically, both ends of a glass tube 21 are sealed, and electrodes 22 and 23 are formed to enclose both ends of the lamp at the outside. Through the external electrodes 22 and 23, an electric field is formed within the glass tube 21, thereby electrically discharging a gas. In addition, a fluorescent substance 24 is applied on an inner wall of the glass tube 21. An inner space 25 of the glass tube 21 is filled with a gas compound, containing e.g., mercury (Hg) vapor, argon, (Ar), neon (Ne), etc.

In general, the processes for manufacturing a fluorescent lamp includes applying a fluorescent substance on an inside of a thin tube, baking the fluorescent substance, discharging a gas from the baked lamp, and sealing the lamp after injection of the gas compound. In order to perform the aforementioned processes, a fluorescent substance application device, a baking device, and a gas discharging device are respectively used. The fluorescent substance applied on the inner wall of the glass tube is baked by heating the lamp at a high temperature. Due to high temperatures required for the baking process, the glass tube may bend or deform.

### SUMMARY OF THE EMBODIMENTS

An object is to provide an apparatus and a method for baking a fluorescent lamp.

Another object is to prevent deformation or bending of the fluorescent lamp.

Another object is to enable a secure transfer of the fluorescent lamp.

### BRIEF DESCRIPTION OF THE DRAWINGS

The embodiments will be described in detail with reference to the following drawings in which like reference numerals refer to like elements wherein:

FIG. 1 illustrates a structure of cold cathode fluorescent lamp (CCFL);

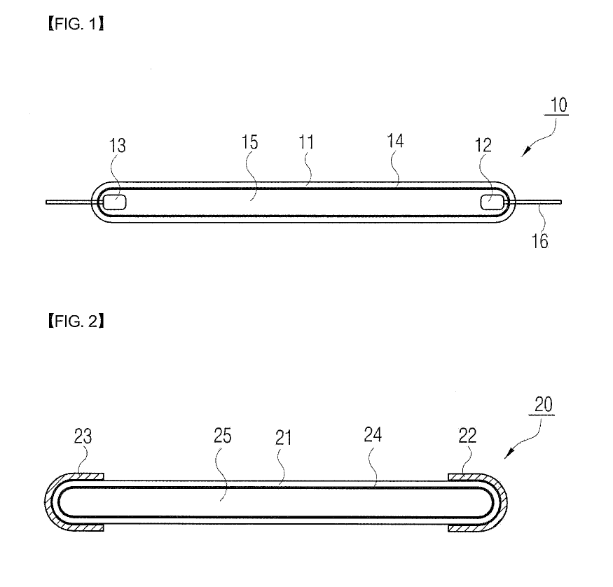

FIG. 2 illustrates the structure of an external electrode fluorescent lamp (EEFL);

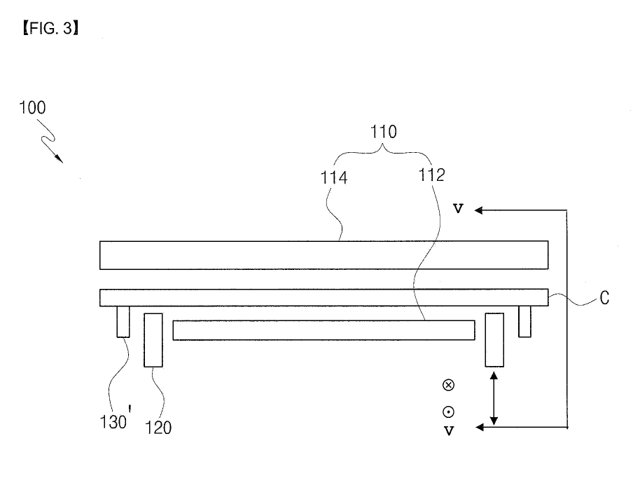

FIG. 3 is a view schematically showing a fluorescent lamp baking apparatus according to an embodiment;

FIG. 4 is a view showing a quartz tube and a fluorescent lamp of FIG. 3;

FIG. 5 is a view showing a transfer block and a rotating roller of FIG. 3 along V-V; and

FIG. 6 and FIG. 7 are views illustrating the operation of the fluorescent lamp baking apparatus shown in FIGS. 3 and 4.

### DETAILED DESCRIPTION

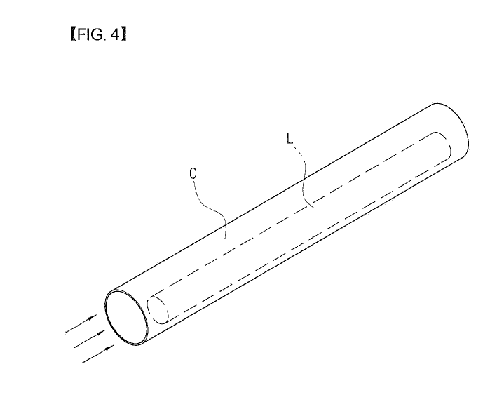

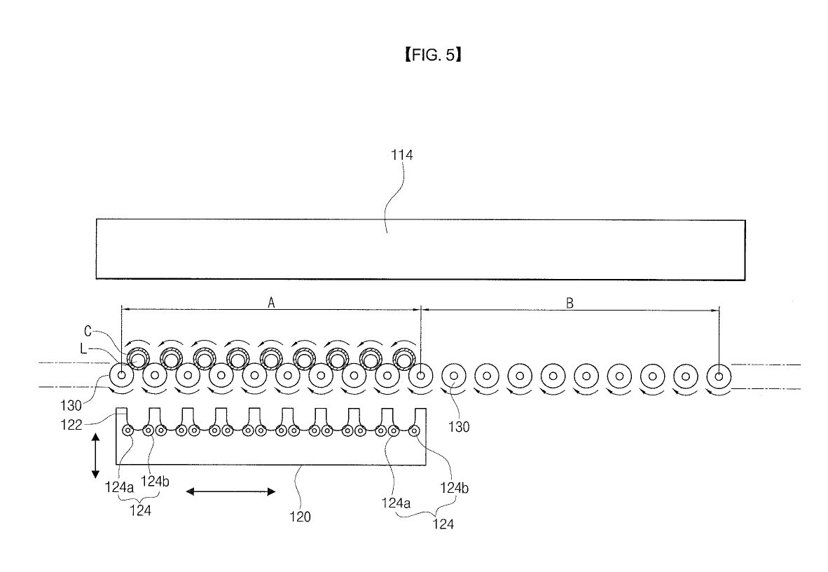

FIG. 3 schematically shows an apparatus for baking a fluorescent lamp, according to an embodiment. The fluorescent lamp baking apparatus comprises a heater 110, a transfer block 120, and a rotation unit 130′. The heater 110 includes a lower heater 112 and an upper heater 114. The heater 110 heats the quartz tubes (C) from an upper direction and well as a lower direction. As shown in FIG. 4, the fluorescent lamp (L) is provided inside the quartz tube (C).

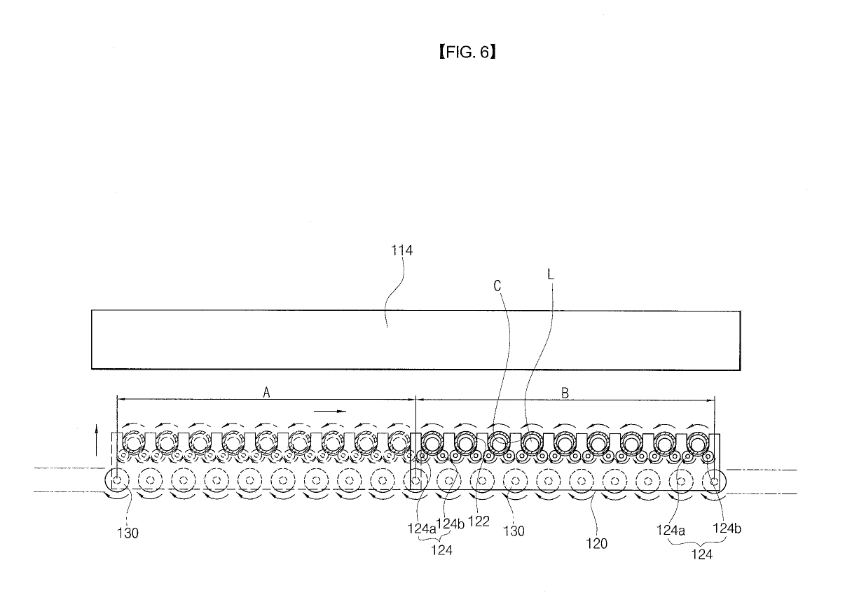

FIG. 5 provides a more detailed illustration of FIG. 3 along V-V. The rotating unit 130′ includes a plurality of rotating rollers 130, which are arranged side by side in a space formed between the lower heater 112 and the upper heater 114. A plurality of quartz tubes C, each having fluorescent lamps L therein, are disposed on an upper part of the rotating rollers 130. The lower heater 112 and the upper heater 114 heat the quartz tube C passing through between them, thereby baking a fluorescent substance applied on an inner surface of the fluorescent lamp L.

The rotating rollers 130 rotate while supporting of the sides of the quartz tube C. The quartz tube C is uniformly heated due to the heat generated from the upper and lower direction and due to the rotation of the rotating rollers 130. As shown in FIG. 3, the transfer block 120 is provided adjacent to sides of the lower heater 112, and is disposed inwardly from the rotating rollers 130, thereby supporting parts of the quartz tube C disposed within the sides supported by the rotating rollers 130. The transfer block 120 moves in upward and downward directions [symbol] and lateral directions [symbol] In one embodiment, the transfer block may move along a closed loop, e.g., performing upward, lateral, downward and then lateral movements in sequence.

As shown in FIG. 5, the rotating rollers 130 are in a substantially horizontal arrangement. The quartz tube C is placed on the upper part of the rotating rollers 130. Since the quartz tubes are disposed between two rotating rollers 130, they are supported by a respective side of each rotating roller 130, and when the rotating rollers 130 are rotated in a clockwise direction, the quartz tubes C are rotated in a counterclockwise direction. The upper heater 114 and the lower heater 112 are arranged to be substantially parallel with the arrangement of the rotating rollers 130 (see also FIG. 3), and therefore heat the quartz tubes C as they are being rotated by the rotating rollers 130.

The rotating rollers 130 can be divided into rollers of a section A and rollers of a section B. The quartz tubes C disposed in the section A are heated for a predetermined time and then transferred to section B for further heating. In another embodiment, the heating temperature in the section B may be higher than the heating temperature in the section A. The temperature of the quartz tubes C being heated may be gradually increased as they are being transferred. The upper heater 114 or the lower heater 112 may also be divided into sections, each section heating the quartz tubes C at respectively different temperatures. Each of the lower heater 112 and the upper heater 114 may also comprise a plurality of sub-heaters, each sub-heater set to a different temperature for each section.

The transfer block 120 includes a plurality of receiving grooves 122 which are provided in parallel with the rotating rollers 130. The receiving groove 122 may have a depth substantially equal to a diameter of the quartz tube C such that the quartz tube C may not be displaced from the receiving groove 122 while being rotated by the auxiliary rollers 124. As shown in FIG. 5, the auxiliary rollers 124 may be disposed on both sides of the receiving grooves 122. Each auxiliary roller 124 may comprise first and second rollers 124a and 124b. The first roller 124a is disposed on a first side of a lower part of the receiving groove 122 while the second roller 124b is disposed on a second side of the lower part of the receiving groove 122. The auxiliary roller 124 supports the quartz tube C inserted in the receiving groove 122 and rotates the quartz tube C. In an alternative embodiment, a single roller may be provided at the bottom of the receiving groove 122.

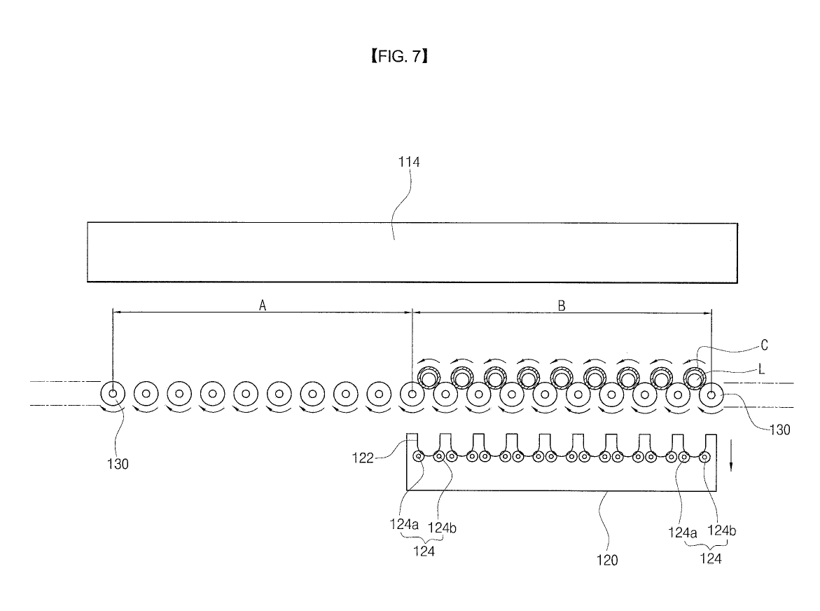

FIGS. 6 and 7 illustrate the operation of the apparatus shown in FIGS. 3 and 5. The fluorescent lamp L is inserted in the quartz tube C, as shown in FIG. 4, and the quartz tube C placed between the rotating rollers 130 in the section A is rotated by the rotating rollers 130, as shown in FIG. 5. The lower heater 112 and the upper heater 114 heat the quartz tubes C disposed in the section A. The quartz tubes C may be uniformly heated as they are rotated.

As shown in FIG. 6, the transfer block 120 moves in an upward direction (↑) and accordingly, the quartz tubes C are disposed in the respective receiving grooves 122, while being lifted from the rotating rollers 130. The quartz tubes C placed in the receiving grooves 122 are supported and rotated by the auxiliary rollers 124a and 124b. The rotational direction of the auxiliary rollers 124 may be the same as or opposite to the rotational direction of the rotating rollers 130. Thereafter, the transfer block 120 moves in a lateral direction (→) from section A to section B.

As shown in FIG. 7, the transfer block 120 moves in a downward direction (↓). Accordingly, the quartz tubes C are disposed between the respective rotating rollers 130 disposed in section B and are rotated. The rotation of the rollers 130 of section B may be the same or different from the rotation of the rollers in section A. The lower heater 112 and the upper heater 114 heat the quartz tubes C disposed in the section B. The quartz tubes C may be heated uniformly as they are rotated. When the heating is completed, the quartz tubes C in the section B are transferred from the section B by a dedicated transfer block (not shown).

Meanwhile, in the section A, new quartz tubes C are placed and heated by the heater 110. The transfer block 120 reciprocates back to the initial position of FIG. 5, which completes a movement locus of a square closed loop. After the quartz tubes C are heated, the transfer block 120 transfers the quartz tubes C from the section A to the section B in the same manner as explained above.

In one embodiment, an apparatus for baking a fluorescent lamp, may comprise a heater that heats a plurality of quartz tubes, each receiving a fluorescent lamp therein; a rotation unit comprising a plurality of rotating rollers that rotate the quartz tubes placed thereon, wherein the rotation unit is disposed on one side of the heater; and a transfer block having a plurality of auxiliary rollers that rotates the quartz tubes placed thereon, wherein the transfer block transfers the quartz tubes placed on the auxiliary rollers. In one embodiment, the quartz tubes are disposed between two adjacent auxiliary rollers.

The transfer block may comprise a plurality of receiving grooves disposed between the two adjacent auxiliary rollers to receive the quartz tubes, and the auxiliary rollers rotates the quartz tubes received in the receiving grooves. The auxiliary rollers may each comprise first and second auxiliary rollers disposed on both sides of each receiving groove, and spaced apart from bottoms of the receiving grooves. The heater may comprise an upper heater disposed at the upper part of the quartz tubes and a lower heater disposed at the lower part of the quartz tubes. The upper and the lower heaters arranged are substantially parallel with the arrangement of the quartz tubes.

In another embodiment, a method for baking a fluorescent lamp, may comprise rotating a plurality of quartz tubes placed between rollers and each include a fluorescent lamp inserted therein, heating the quartz tubes, and transferring the quartz tubes using a transfer block, wherein the transferring step comprises rotating the quartz tubes on the transfer block. The rotating step may comprise placing the quartz tubes in the receiving grooves of the transfer block, and rotating the quartz tubes within the receiving grooves.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An apparatus for baking a fluorescent lamp, comprising:
a heater to heat a plurality of quartz tubes, each having a fluorescent lamp provided therein;
a plurality of rollers to rotate the quartz tubes placed thereon; and
a transfer block having a plurality of auxiliary rollers, wherein the transfer block is configured to move in a first direction to transfer the plurality of quartz tubes from the plurality of rotating rollers to the plurality of auxiliary rollers.

2. The baking apparatus according to claim 1, wherein each quartz tube is disposed between two auxiliary rollers.

3. The baking apparatus according to claim 1, wherein the transfer block further comprises a plurality of grooves to receive the quartz tubes, and corresponding auxiliary rollers are configured to rotate the quartz tubes received in the grooves.

4. The baking apparatus according to claim 3, wherein each auxiliary roller comprise first and second auxiliary rollers disposed on both sides of each groove and spaced apart from a bottom of each groove.

5. The baking apparatus according to claim 1, wherein the heater comprises an upper heater provided above the plurality of rollers and a lower heater disposed below the plurality of rollers, wherein the upper and the lower heaters are arranged to be substantially parallel to each other.

6. The baking apparatus according to claim 1, wherein the rotating rollers are divided into at least two sections, and each section is heated at a prescribed temperature.

7. The baking apparatus of claim 6, wherein the transfer blocks moves in a lateral direction to transfer the plurality of quartz tube to a different section.

8. The baking apparatus of claim 7, wherein the transfer block moves in a closed loop.

9. A process for heating at least one fluorescent lamp comprising:
providing a plurality of quartz tubes on a plurality of rotating rollers, at least one quartz tube having the at least one fluorescent lamp provided therein;
heating the plurality of quartz tubes while being rotated on the plurality of rollers; and
transferring the plurality of quartz tube using a transfer block having a plurality of auxiliary rollers.

10. The method of claim 9, wherein the plurality of quartz tubes are heated by an upper heater and a lower heater.

11. The method of claim 9, wherein the quartz tubes are transferred while rotating the plurality of auxiliary rotating rollers.

12. The method of claim 9, wherein the transfer block further includes a plurality of grooves to receive the plurality of quartz tubes, and the quartz tubes are rotated in the grooves by the plurality of auxiliary rollers.
